(19) United States
(12) Patent Application Publication
(10) Pub. No.: US 2009/0059788 A1
(43) Pub. Date: Mar. 5, 2009

(54) Method and Apparatus for Dynamic Adaptation of Network Transport

(75) Inventors: Yuri Granovsky, Tel-Aviv (IL); Uri Kogan, Nesher (IL); Michael Spivak, Netania (IL); Adam C. Lewis, Buffalo Grove, IL (US); Christophe Beaujean, Arpajon (FR); Vidya Narayanan, San Diego, CA (US); George Popovich, Palatine, IL (US)

Correspondence Address: LEVEQUE INTELLECTUAL PROPERTY LAW, P.C., 221 EAST CHURCH ST., FREDERICK, MD, 21701, US

(73) Assignee: MOTOROLA, INC., Schaumburg, IL (US)

(21) Appl. No.: 11/846,756

(22) Filed: Aug. 29, 2007

(51) Int. Cl. H04L 12/26; H04L 12/56

(52) U.S. Cl. 370/235; 370/392

(57) ABSTRACT

An intermediate device of a network includes network and transport layers, a dispatcher, a splitter and a connections database. The splitter intercepts a message packet in the network layer and modifies the network routing header and transport header of the message packet to form a modified message packet. The dispatcher receives modified message packets from the transport layer, recovers information from the message packets, passes the modified message packets back to the transport layer and adapts the transport layer to adapt communication dependent upon the information recovered from the message packets. The connections database stores the original source address, the original destination address, the original source port identifier and the original destination port identifier of an incoming message packet. A message packet is modified, with reference to the connections database, so that message packets from the first and second nodes are routed through the dispatcher.

### FIELD

This invention relates generally to the field of communication over a network. More particularly, this invention relates to the optimization of communication in a network that includes one or more wireless links.

### BACKGROUND

Transmission Control Protocol (TCP) is widely used for connection-oriented communication over networks and has been designed to provide reliable end-to-end communication over the Internet. Some variations to TCP include congestion control mechanisms, such as Slow Start, Congestion Avoidance, Fast Retransmit, Fast Recovery and Random Early Detection (RED). These mechanisms are used primarily to avoid collisions, but may significantly reduce throughput for Wireless links.

A variety of modifications and alternatives to TCP have been proposed. However, it is unlikely that a particular scheme will be optimal for all links at all times.

One widely used variation of TCP is TCP Reno. Under this protocol, a sender maintains a congestion window, limiting the total number of unacknowledged packets that may be in transit end-to-end. TCP Reno fails to consider wireless optimization and a TCP stack replacement on a correspondent node is generally unavailable.

Existing TCP optimization techniques are intended to facilitate the use of TCP in Wireless Networks. Some of the techniques seek to automatically adjust the congestion control parameters: Slow Start Threshold (ssthresh), and Congestion Window (cwin). Current end-to-end TCP optimization techniques include TCP Westwood and TCP Real. Implementation of these techniques requires modification to protocol software on one or both end-point devices. Thus, the techniques are difficult to implement on existing devices.

TCP Westwood (TCPW), for example, is a sender-side-only modification to TCP Reno that is intended to improve handling of large bandwidth-delay product paths (large pipes), with potential packet loss due to transmission or other errors (leaky pipes), and with dynamic load (dynamic pipes). However, this protocol requires modifications to the sender's TCP stack.

TCP splicing has been proposed for applications such as Applicative Firewall/Security Operations Center, failover, Wired Equivalent Privacy (WEP encryption) Proxy, etc., in client-server networks. In particular, TCP splicing is used to move protocol execution away from Application and Transport (TCP) layers to an Internet Protocol (IP) kernel space area. Thus, TCP splicing diverts packets away from the stack to an IP kernel. TCP splicing may allow significant performance improvement comparing with Proxy applications running at user space. TCP splicing has not been used for transport optimization and requires additional software on the client device.

### BRIEF DESCRIPTION OF THE DRAWINGS

The novel features believed characteristic of the invention are set forth in the appended claims. The invention itself, however, as well as the preferred mode of use, and further objects and advantages thereof, will best be understood by reference to the following detailed description of an illustrative embodiment when read in conjunction with the accompanying drawing(s), wherein:

FIG. 1 is a simplified block diagram of a connection-oriented communication network in accordance with certain embodiments of the present invention.

FIG. 2 is a block diagram of an exemplary intermediate device in accordance with certain aspects of the present invention.

FIG. 3 is a flow chart of a method in accordance with some embodiments of the present invention.

FIG. 4 is a flow chart of a method in accordance with some embodiments of the present invention.

FIG. 5 is a flow chart associated with operation of an exemplary splitter in accordance with some embodiments of the invention.

FIG. 6 is a further flow chart associated with operation of an exemplary splitter in accordance with some embodiments of the invention.

### DETAILED DESCRIPTION

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the description below, like reference numerals are used to describe the same, similar or corresponding parts in the several views of the drawings.

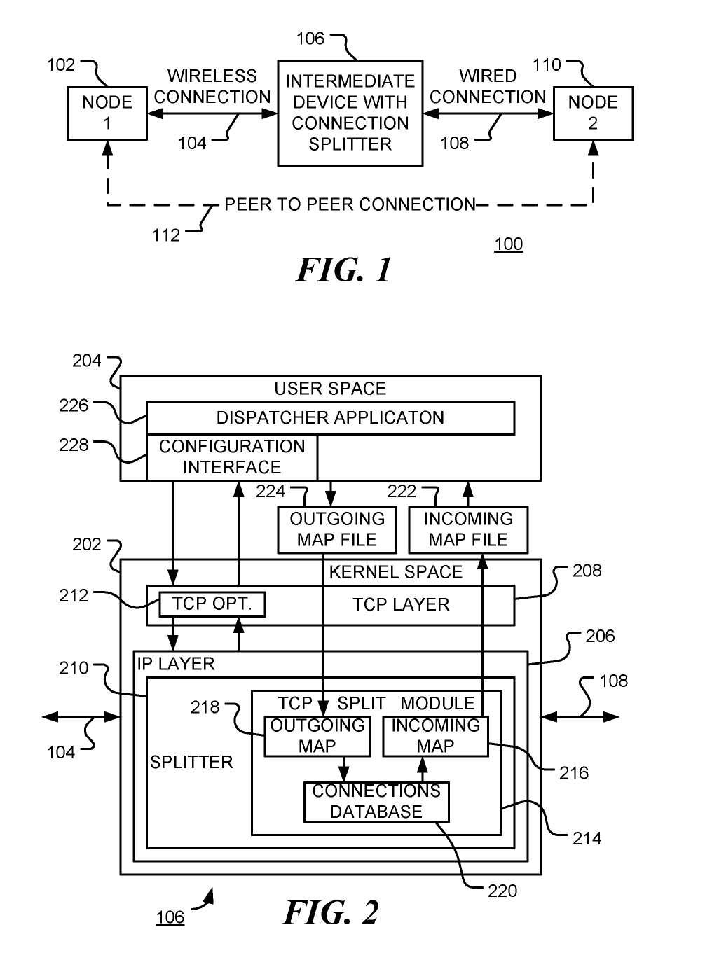

FIG. 1 is a simplified block diagram of a connection-oriented communication network 100 in accordance with certain embodiments of the present invention. The network 100 includes a first network node 102, that may be a mobile device such as a cellular telephone, personal digital assistant or portable computer for example, that is connected via a wireless connection 104 to a middleware or intermediate device 106. The wireless connection may be a radio link, for example. In turn, intermediate device 106 is connected via a wired connection 108 to a second node 110. The first node 102 and second node 110 may communicate with one another using connection-oriented communication protocol. A widely used connection-oriented communication protocol is the Transmission Control Protocol (TCP) that operates over an underlying network protocol such as the Internet Protocol (IP), which is referred to as TCP/IP. Various embodiments are described below with reference to TCP/IP. However, it is to be understood that other connection-oriented communication protocols may be used. In general, the protocol will include a network layer that controls routing of data packets within the network (usually without reference to the ordering of packets) and a transport layer that controls streams of information between particular nodes (peers). A transport protocol may also specify a port identifier that enables a node to maintain more than one connection at a time and may also specify how the data is to be interpreted. Transport protocols usually use some form of handshaking, such as acknowledgment (ACK) messages to ensure that data in a stream is not lost or received out of order. Both the network routing and transport functions may be performed by a computer or other processor.

In accordance with one embodiment of the present invention, the intermediate device 106 includes a connection splitter and is operable to optimize the connection 104 between the first node 102 and the intermediate node 106. In turn, this optimizes the peer-to-peer connection 112 between the first node 102 and the second node 110.

The intermediate device 106 may be, for example a Network Access Server (NAS), any tunneling Gateway (VPN, MIP Home Agent, L2TP, PPP, etc), or any device through which the communication between the first and second nodes passes.

In accordance with some embodiments of the invention, an intermediate device of a network includes network routing and transport layers, a dispatcher, a splitter and a connections database. The splitter intercepts a message packet in the network layer and modifies the network header and transport header of the message packet to form a modified message packet. The dispatcher receives modified message packets from the transport layer, recovers information from the message packets, passes the modified message packets back to the transport layer and adapts the transport layer to adapt communication dependent upon the information recovered from the message packets. The connections database stores the original source address, the original destination address, the original source port identifier and the original destination port identifier of an incoming message packet. A message packet is modified, with reference to the connections database, so that message packets from the first and second nodes are routed through the dispatcher.

Further embodiments of the invention include a method for an intermediate device to adapt communication between a first node and a second node of a network operable under a protocol having a network layer and a connections layer. In accordance with the method, a message packet is intercepted in a network layer of an intermediate device. The message packet including an original source address and an original destination address in a network routing header and an original source port identifier and an original destination port identifier in a transport header. If the message packet is a request from the first node to the second node to open a connection, an entry is made in a connections database, the entry including the original source address, the original source port identifier, the original destination address and the original destination port identifier. Also, the first node is connected to a first port of a dispatcher application and the second node is connected to a second port of the dispatcher application.

The dispatcher application adapts the transport layer so as to optimize communication between the first node and the second node.

FIG. 2 is a block diagram of an exemplary intermediate device in accordance with certain aspects of the present invention. The intermediate device 106 includes a kernel space 202 that implements the communication protocol and a user space 204. The kernel space 202 includes an Internet Protocol (IP) layer 206 and a Transmission Control Protocol (TCP) layer 208. In the Linux operating system, the Internet Protocol (IP) layer 206 is implemented as a Netfilter, which provides a number of hooks that enable access to and modification of the data at various points within the stack. The splitter 210 resides in the IP layer 206, while the TCP optimization module 212 resides in the TCP layer 208. The splitter includes a TCP split module 214 that comprises an incoming map 216, an outgoing map 218 and a connections database 220. The incoming map provides connection information to the user space via an incoming map file 222 and the outgoing map receives connection information from the user space via the outgoing map file 224. The connections information is stored in the connections database 220.

The TCP optimization module 212 operates to optimize the wireless link. This optimization may be performed automatically dependent upon the underlying link technology's performance profile. In one embodiment, the configuration interface 228 is exposed to an administrator (via an application programmer interface (API), for example) to enable the input of link characteristics such as delay, bandwidth, error rates, etc. The optimization module would then select an optimization or acceleration algorithm dependent upon these characteristics. Thus, transparent to both the sending and receiving nodes, the wireless link is dynamically adapted. In a further embodiment, the optimization or acceleration algorithm is selected by the administrator via the interface.

In contrast, prior approaches have required modifications to be made to the sending and/or receiving nodes and use a single, fixed protocol that do not allow the input of link characteristics. Some satellite communication acceleration packages allow the tuning of acceleration via ‘mission’ parameters, but these are suitable only for one specific link type. The present invention enables automatic adaptation of a plurality of protocols for a plurality of wireless links, based upon the link characteristics.

If the message packet is an incoming message packet, the original destination address is changed to be the address of a dispatcher application and the connections database is examined to determine if there exists an entry in the connections database for which the source address and source port fields match the message packet's original destination and original port identifier. If such an entry exists, the message packet's original destination port identifier is changed to be the second port identifier of the dispatcher application. Otherwise, if no such entry exists, the message packet's original destination port identifier is changed to be the first port identifier of the dispatcher application. The message is then forwarded to the dispatcher application via a transport layer.

If the message packet is an outgoing message packet received from the dispatcher application via the transport layer and the source port identifier of the message packet is the first port identifier of the dispatcher application, it is determined if there exists an entry in the connections database for which the original source address and original source port identifier match the message packet's destination address and port identifier. If such an entry exists, the message packet's source address and source port identifier are replaced with the values written in the entry's destination address and destination port identifier fields.

If the message packet is an outgoing message packet received from the dispatcher application via the transport layer and the source port identifier of the message packet is the second port identifier of the dispatcher application, it is determined if there exists an entry in the connections database for which the original source address and original source port identifier match the message packet's destination address and port identifier, and, if such an entry exists, the message packet's source address and source port identifier are replaced with the values written in the entry's source address and source port identifier fields.

In accordance with one embodiment of the invention, the TCP optimization module uses the Westwood TCP optimization algorithm in order to optimize the connection between the intermediate device and the first node. This algorithm is currently implemented in the Linux kernel. For this embodiment, modifications are needed to pass the data flow all the way up to the user space and down through the TCP layer. The connection split is used to pass the data flow through the Linux TCP layer on the intermediate device. In contrast to prior implementations of the Westwood TCP, no modifications to the sender's TCP stack are required.

The user space 204 includes a dispatcher application 226 that provides a configuration interface 228 to allow configuration of the TCP optimization module 212 in the TCP layer 208 of the kernel space 202.

In this approach, the interface between the splitter 210 and the dispatcher application 226 is handled without changing TCP data. This allows the TCP optimization to be performed for all TCP connections regardless of the TCP frame size. In addition, no modification of the TCP peers is required.

The functionalities of TCP split module include:

(1) Supplying the destination/source IP address and TCP port of a new incoming connection to dispatcher application. The dispatcher application will use this information for the original connection completion at the connection initiation stage.

(2) Delivering the packets to local machine instead of forwarding them through. It will change packets destination IP address and port to IP address and port on which the dispatcher application is listening. The change is done to direct the packet to the local TCP layer and to dispatcher application in user space.

(3) Restoring the original source IP address and port of outgoing packet in order to hide the connection split from destination node. The information about the original source IP address and port for the outgoing packet will be acquired from connections database using outgoing map data structure.

In connections database the information for every connection will be stored. This will include three pairs:

(1) Original source IP address and port identifier pair

(2) Original destination IP address and port identifier pair

(3) Local IP address and port identifier (for the completing connection).

In one embodiment of the invention, the connections database is implemented as a Red-Black Tree structure, comprising of two connection maps for outgoing and incoming packets. On the basis of these maps the splitter sets appropriate IP address and TCP port. The information stored in connections database may be accessed via outgoing and incoming data structures. The outgoing and incoming data structures will use different keys for searching connection information.

The functions of the dispatcher application are:

(1) Accepting incoming connections.

(2) Reading new incoming connection information from the TCP split module via the communication pipe.

(3) Informing the kernel about new outgoing connection (split connection). This information will be used for changing the IP-port of the outgoing packets.

(4) Creating outbound connection to the original destination.

(5) Waiting on sockets for data in both directions of the connection and acting as a transparent proxy for all the data between two connection parts.

(6) Closing the connection pair and exiting the thread when a connection is closed.

By way of explanation of the operation of the TCP splitter, a specific example is now considered, in which node A wishes to connect with node B using file transmission protocol (FTP). The process has two phases: connection initiation and regular data flow.

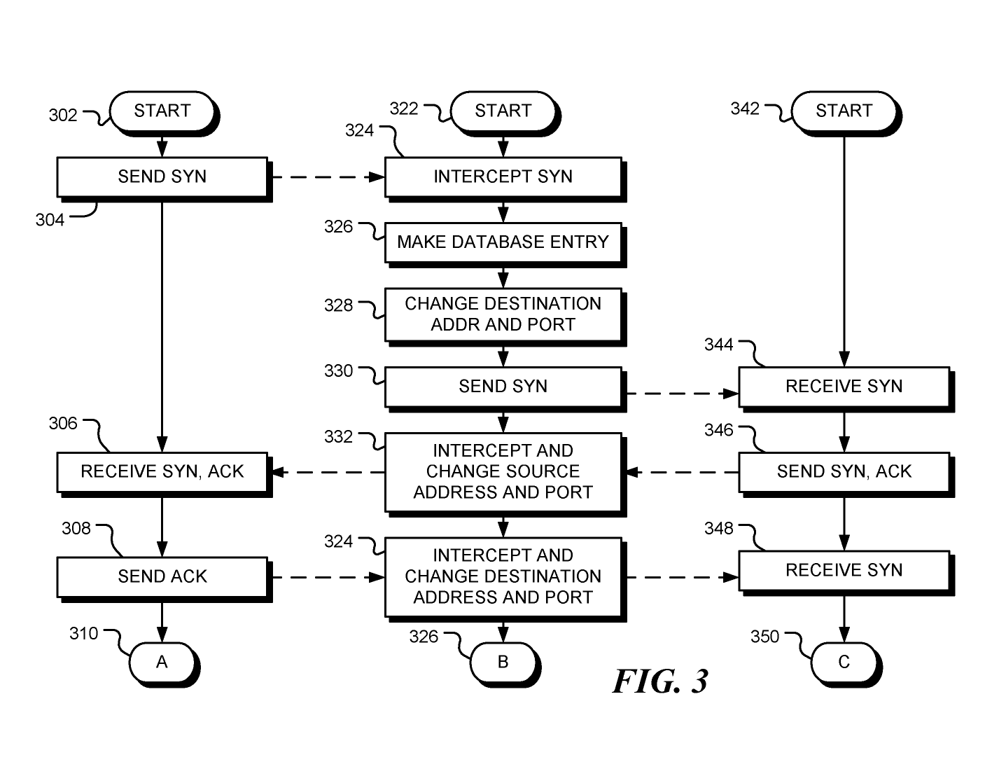

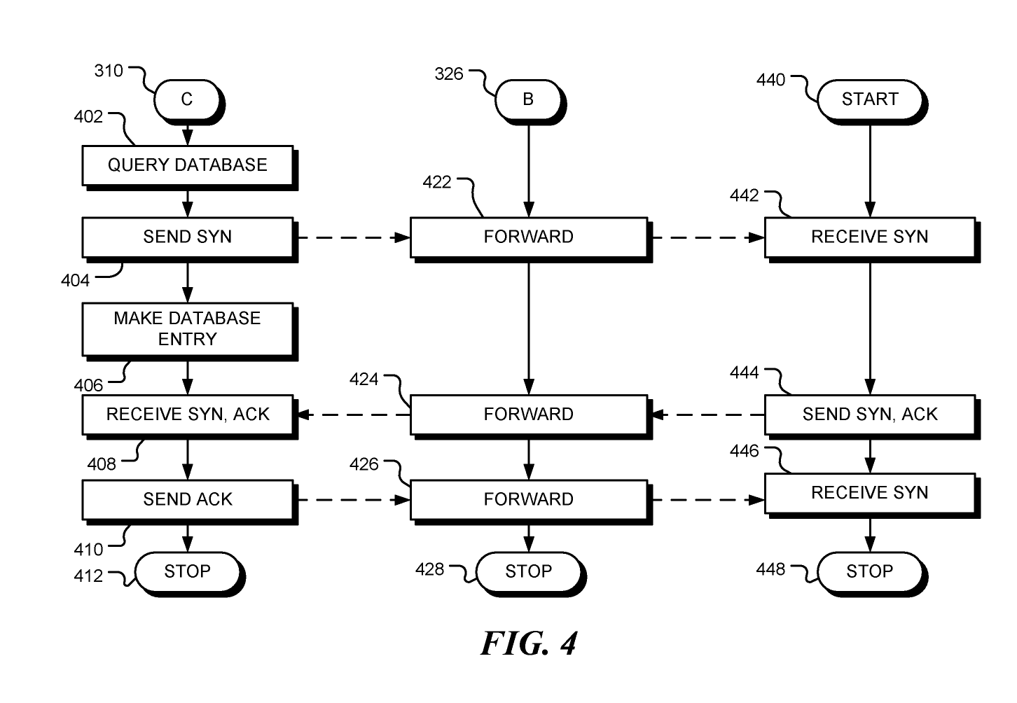

The connection initiation phase is shown in FIGS. 3 and 4. FIG. 3 is a flow chart of methods performed by a mobile node (node A), a TCP splitter and a dispatcher application. Following start block 302, node A sends a packet with source IP 192.168.1.2, source port 8000 (for example), destination IP 192.168.0.2, destination port 21 (FTP), SYN flag set, ACK flag not set, at block 304. The splitter, operating in the kernel space of an intermediate device following start block 322, intercepts this packet at block 324, and since the packet includes {SYN=1, ACK=0}, it makes a new entry in the connections database at block 326. In this example, the entry includes the following data:

Local IP=192.168.1.1

Local port=2048

Destination IP=192.168.0.2

Destination port=21

Original Source IP=192.168.1.2

Original Source port=8000

The first local port identifier or address, 2048 in this example, is the identifier of the local port for node A. That is port of the dispatcher application to which node A (the original source node) is to be connected. This At block 328, the splitter then changes the packet's destination IP and port to be the IP and port on which the dispatcher application is accepting connections (in user space), i.e. 192.168.1.1:2048. Operation of the dispatcher application begins at start block 342. At block 344, the dispatcher application accepts the packet, and has to complete the three-way handshake. At block 346, it sends a SYN/ACK packet, destined to 192.168.1.2:8000. The splitter catches this packet at block 332, and because the packet's source port equals to 2048, it knows that the packet should be destined to the original source (192.168.1.2). It queries the connections database for an entry with Original Source IP and Original Source port fields that match the packet's destination IP and port, and replaces the packet's source IP and port to be the Destination IP and Destination port fields of the node. The package is received by node A at block 306 and node A sends a final ACK message at block 308. The final ACK is handled like the first SYN by the driver, except that no new entry is inserted into the tree. That is, at block 324, the database is queried and the destination IP address and port are changed to match to the IP and port on which the dispatcher application is accepting connections (in user space), i.e. 192.168.1.1:2048. The final ACK is received by the dispatcher application at block 348.

Now that the three-way handshake is over (the dispatcher application's accept( ) call is over), the dispatcher application should connect the original destination on behalf of the original source. Node A has completed its connection process and flow terminates at block 310. For the splitter and the dispatcher application, flow continues, at blocks 326 and 350 respectively with corresponding blocks in FIG. 4. Referring to FIG. 4, the dispatcher application queries the connections database at block 402 for an entry with Original Source IP and Original Source port that match the remote IP and port of the socket (returned by an accept( ) call, for example). It then determines the original destination IP and port from the entry, and connects this destination (via a connect( ) call, for example). It does this by sending a packet with the SYN flag set, ACK flag not set, at block 404. The connection with the original destination is done from a different (second) port. The second local port identifier or address, 4000 in this example, is the identifier of the local port for node B. That is, the identifier of the port of the dispatcher application to which node B (the original destination node) is to be connected. The dispatcher application modifies the entry in the connections database, at block 406, to hold the new local port identifier (4000).

Local IP=192.168.1.1

Local port=4000

Destination IP=192.168.0.2

Destination port=21

Original Source IP=192.168.1.2

Original Source port=8000

The SYN packet is forwarded by the splitter at block 422 to the original destination (node B) to initiate a three-way handshake. Following start block 440, node B receives the SYN packet at block 442 and responds at block 444 with a corresponding SYN/ACK packet. This is forwarded by the splitter, at block 424, to the dispatcher application, which receives the SYN/ACK packet at block 408. The final ACK packet is sent by the dispatcher application at block 410, is forwarded by the splitter at block 426 and is received by node B at block 446. The connection between the dispatcher application and node B is now completed and the processes for the dispatcher application, the splitter and node B terminate at blocks 412, 428 and 448, respectively.

After this handshake is over, the dispatcher application no longer needs the connections database entry for this connection. The dispatcher application continues accepting new connections and handling them as described above. A thread will now take over the connection in this example. Such a thread will be created for each new connection. This thread monitors the tunnelling of data between the two parties (192.168.1.2, 192.168.0.2). It holds two sockets, one for communicating with each party. Once data can be read on one of these sockets, the thread reads the data and immediately writes it into the other socket.

It will be apparent to those of ordinary skill in the art that the handshake with the original destination may be performed prior to the handshake with the original destination.

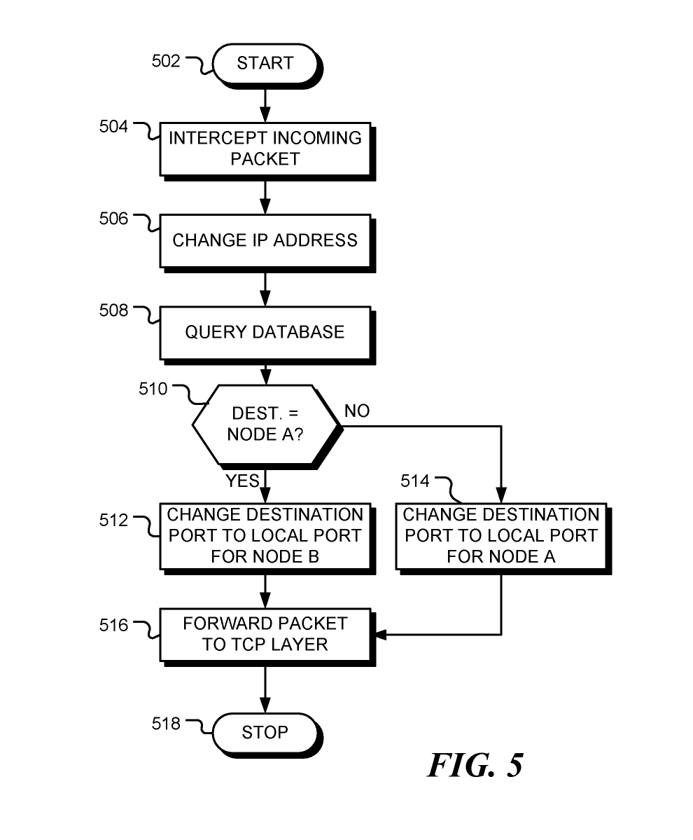

FIG. 5 is a flow chart associated with operation of the splitter in the Regular Data Flow phase, in accordance with some embodiments of the invention. Following start block 502 in FIG. 5, the splitter intercepts an incoming packet at block 504. Incoming data packets are directed to the dispatcher application. Hence, at block 506, the splitter changes the packet's destination IP address to dispatcher application's IP address. The splitter examines the packet's destination IP and port and queries the connections database at block 508. If there is an entry in the connections database whose original source IP and original source port fields match the packet's destination IP and port, as depicted by the positive branch from decision block 510, the packet is determined to be coming from the original destination (192.168.0.2) and, at block 512, the packet's destination port is changed to the local port for node B (4000 in this example). This value (4000) is extracted from the entry (in the database tree structure). If there is no such entry, as depicted by the negative branch from decision block 510, the packet is coming from the original source (192.168.1.2), so the packet's destination port is changed to local port for node A (2048 in this example) at block 514. In this example, the value (2048) is fixed. The altered packet is then forwarded, via the TCP stack, to the dispatcher application. The processing of the incoming packet is now completed and the process terminates at block 518.

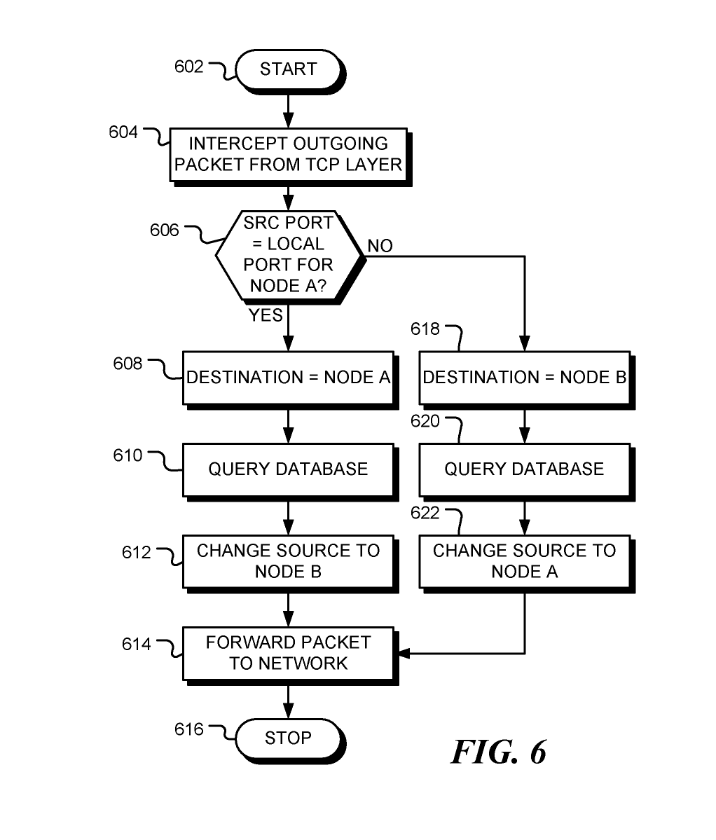

FIG. 6 is a further flow chart associated with operation of the splitter in the Regular Data Flow phase, in accordance with some embodiments of the invention. Following start block 602 in FIG. 6, the splitter intercepts an outgoing packet at block 604. Outgoing packets are always coming from the dispatcher application. Hence the driver should change the packet's source IP and port, depending on the packet's source port. In this example, the source port can be either 2048 or 4000. The driver examines the packet's source port at decision block 606. If the source port equals to the dispatcher application's local listening port (2048), as depicted by the positive branch from decision block 606, the packet is destined to the original source (node A), as indicted by block 608. The splitter queries the connections database at block 610 to look for an entry whose Original source IP and Original source port match the packet's destination IP and port, and, at block 612, replaces the packet's source IP and port with the values written in the entry's destination IP and port fields. The modified packet is forwarded to the network at block 614. The processing of the outgoing packet is now completed and the process terminates at block 616. If the source port is not equal to the dispatcher application's local listening port (2048), as depicted by the negative branch from decision block 606, the packet is destined to the original destination (node B) as indicated by block 618. The driver queries the connections database at block 620 to look for an entry, whose source port matches the packet's source port, and, at block 622, replaces the packet's source IP and port with the values written in the entry's Original source IP and Original port fields, which correspond to node A. The processing of the outgoing packet is now completed and the process terminates at block 616.

The prior technique of TCP splicing incorporates TCP application logic (e.g. Applicative Firewall/SOCS, failover, WEP Proxy, etc.) with the intention of moving protocol execution away from Application and Transport (TCP) layers to an IP kernel space area. Usually it allows significant performance improvement comparing with Proxy applications running at user space. However, applying TCP splice technique for TCP optimization would demand additional TCP stack implementation (TCP Windows handling, retransmissions mechanism, congestion control, etc).

One embodiment of the TCP splitter of the present invention includes utilizing an existing TCP optimization stack (such as Linux stack) which is well checked and may be employed for any TCP application. For example, packets may be forwarded to the TCP stack of a Linux middleware host. Thus, the TCP splitter moves packets to the TCP stack whereas, in contrast, TCP splice diverts packets away from the stack to an IP kernel.

Further, TCP splicing imposes a client-server scheme where the client initiates TCP session, whereas the present invention relates to any TCP connection scheme between two TCP peers.

Still further, TCP splicing requires additional software on the client device, while the TCP splitter doesn't require any additional any software on the client device. As shown in FIG. 1, the software for the TCP splitter is deployed only on middleware device.

The TCP splitter is used as a way to intercept communication and adapt the optimization scheme. It maintains a connection map containing information about all connections that allows TCP splitter implementation with no need to change TCP data segment.

In one embodiment of the invention, the dispatcher application is used to implement a TCP optimization scheme. Current optimization schemes require the sender to perform the optimization, which, in turn requires modification to the TCP software stack on the sending (and/or receiving) device. In contrast, implementation of a TCP optimization scheme on the intermediate device requires no software modification on the sending or receiving devices. Existing optimization schemes include TCP Reno, TCP newReno, TCP Westwood and TCP Westwood+, some of which are outlined below. It will be apparent to those of ordinary skill in the art that other TCP optimization schemes may be implemented by the dispatcher application without departing from the present invention.

A widely used variation of TCP is TCP Reno. Under this protocol, a sender maintains a congestion window (cwin), limiting the total number of unacknowledged packets that may be in transit end-to-end.

The protocol begins in a ‘Slow Start’ phase so as to avoid congestion collapse. The sender makes a slow start when the connection is initialised and after a timeout. The sender starts with a window of twice the maximum segment size (MSS) specified in the protocol. Although the initial rate is low, the rate of increase is very rapid: for every packet acknowledged, the congestion window increases by 1 MSS, so that for every round trip time, the congestion window has doubled. When the congestion window exceeds a threshold ssthresh, or a packet is lost, the algorithm enters a new state, called congestion avoidance. In some implementations (e.g. Linux), the initial ssthresh is large, and so the first Slow Start usually ends after a loss. However, ssthresh is updated at the end of each Slow Start phase, and will often affect subsequent slow starts triggered by timeouts.

The ‘Congestion Avoidance’ mechansim calls for the congestion window to be increased by one MSS every round trip time, as long a non-duplicate acknowledgment messages (ACK's) are received. When a packet is lost, duplicate ACK's will be received. If three duplicate ACK's are received (i.e., four ACK's acknowledging the same packet, which are not piggybacked on data, and do not change the receiver's advertised window), the congestion window is halved, a “fast retransmit” is performed, and a phase called Fast Recovery is entered.

In the ‘Fast Recovery’ phase, the missing packet that was signaled by 3 duplicate ACK's is retransmitted, and the protocol does not return to the ‘Congestion Avoidance’ phase until an acknowledgment of the entire transmit window is received. If there is no acknowledgment, TCP Reno experiences a timeout and enters the Slow-Start state. The congestion window is reduced to 1 MSS on a timeout event.

TCP Westwood+ is a sender-side only modification of the TCP Reno protocol stack that optimizes the performance of TCP congestion control over both wireline and wireless networks. TCP Westwood+ is based on end-to-end bandwidth estimation to set congestion window and slow start threshold after a congestion episode, that is, after three duplicate acknowledgments or a timeout. The bandwidth is estimated by low-pass filtering the rate of returning acknowledgment (ACK) packets. In contrast with TCP Reno, which blindly halves the congestion window after three duplicate ACKs, TCP Westwood+ adaptively sets a slow start threshold and a congestion window which takes into account the bandwidth used at the time congestion is experienced. TCP Westwood+ significantly increases fairness compared to TCP Reno/NewReno in wired networks and throughput over wireless links.

Those of ordinary skill in the art will recognize that the present invention has been described in terms of exemplary embodiments. However, the invention should not be so limited, since the present invention could be implemented using hardware component equivalents such as special purpose hardware and/or dedicated processors, which are equivalents to the invention as, described and claimed. Similarly, general purpose computers, microprocessor based computers, digital signal processors, microcontrollers, dedicated processors, custom circuits, ASICS and/or dedicated hard wired logic may be used to construct alternative equivalent embodiments of the present invention.

Those skilled in the art will appreciate that the program steps and associated data used to implement the embodiments described above can be implemented using disc storage as well as other forms of storage, such as, for example, Read Only Memory (ROM) devices, Random Access Memory (RAM) devices, optical storage elements, magnetic storage elements, magneto-optical storage elements, flash memory and/or other equivalent storage technologies without departing from the present invention. Such alternative storage devices should be considered equivalents.

The present invention, as described in embodiments herein, is implemented using a programmed processor executing programming instructions that are broadly described above in flow chart form that can be stored on any suitable electronic storage medium. However, those skilled in the art will appreciate that the processes described above can be implemented in any number of variations and in many suitable programming languages without departing from the present invention. For example, the order of certain operations carried out can often be varied, additional operations can be added or operations can be deleted without departing from the invention. Error trapping can be added and/or enhanced and variations can be made in user interface and information presentation without departing from the present invention. Such variations are contemplated and considered equivalent.

While the invention has been particularly shown and described with reference to a preferred embodiment, it will be understood by those skilled in the art that various changes in form and detail may be made therein without departing from the spirit and scope of the invention.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

What is claimed is:

1. A method for an intermediate device to adapt communication between a first node and a second node of a network operable under a protocol having a network layer and a connections layer, the method comprising:
intercepting a message packet in the network layer of an intermediate device, the message packet comprising an original source address and an original destination address in a network routing header and an original source port identifier and an original destination port identifier in a transport header;
if the message packet comprises a request from the first node to the second node to open a connection:
making an entry in a connections database, the entry comprising the original source address, the original source port identifier, the original destination address and the original destination port identifier;
connecting the first node to a first port of a dispatcher application; and
connecting the second node to a second port of a dispatcher application;
if the message packet is an incoming message packet:
changing the original destination address to be the address of a dispatcher application;
examining the connections database to determine if there exists an entry in the connections database for which the source address and source port fields match the message packet's original destination and original port identifier;
changing the message packet's original destination port identifier to be the second port identifier of the dispatcher application, if such an entry exists;
changing the message packet's original destination port identifier to be the first port identifier of the dispatcher application if no such entry exists; and
forwarding the message to the dispatcher application via a transport layer;
if the message packet is an outgoing message packet received from the dispatcher application via the transport layer:
if the source port identifier of the message packet is the first port identifier of the dispatcher application further comprising:
determining if there exists an entry in the connections database for which the original source address and original source port identifier match the message packet's destination address and port identifier; and
if such an entry exists, replacing the message packet's source address and source port identifier with the values written in the entry's destination address and destination port identifier fields;
if the source port identifier of the message packet is the second port identifier of the dispatcher application further comprising:
determining if there exists an entry in the connections database for which the original source address and original source port identifier match the message packet's destination address and port identifier; and
if such an entry exists, replacing the message packet's source address and source port identifier with the values written in the entry's source address and source port identifier fields; and
the dispatcher application modifying the transport layer.

2. A method in accordance with claim 1, wherein the network layer comprises an Internet Protocol (IP) layer and the transport layer comprises a Transmission Control Protocol (TCP) layer.

3. A method in accordance with claim 2, wherein the dispatcher application adapts the transport layer comprises the dispatcher application setting parameters of the transport layer dependent upon received acknowledgement (ACK) messages.

4. A method in accordance with claim 3, wherein the parameters of the transport layer comprise congestion control parameters.

5. A method in accordance with claim 1, further comprising:
the dispatcher application setting parameters of the transport layer dependent upon properties of a network link between the first node and the intermediate device.

6. A method in accordance with claim 5, wherein the properties of the network link between the first node and the intermediate device are received from an operator of the intermediate device via a user interface.

7. An intermediate device for adapting communication between a first node and a second node of a network, the intermediate device comprising:
a network layer, operable to send and receive message packets from the first node and the second node, each message packet comprising a source address and a destination address in a network routing header and a source port identifier and a destination port identifier in a transport header;
a transport layer, operable to send and receive message packets from the network layer;
a splitter operable to:
intercept a message packet in the network layer, and
modify the network routing header and transport header of the message packet to form a modified message packet;
a dispatcher, operable to:
receive modified message packets from the transport layer;
recover information from the message packets;
pass the modified message packets back to the transport layer; and
adapt the transport layer to optimize communication dependent upon the information recovered from the message packets; and
a connections database, operable to store the original source address, the original destination address, the original source port identifier and the original destination port identifier of an incoming message packet;
wherein the routing header and transport header of a message packet is modified, with reference to the connections database, such that message packets from the first and second nodes are routed to the dispatcher, and message packets from the dispatcher are routed to one of the first and second nodes.

8. An intermediate device in accordance with claim 7, wherein the network layer comprises an Internet Protocol (IP) layer and the transport layer comprises a Transmission Control Protocol (TCP) layer.

9. An intermediate device in accordance with claim 8, wherein the dispatcher is operable to adapt the transport layer in accordance with a TCP Westwood+ protocol.

10. An intermediate device in accordance with claim 8, wherein the network layer comprises a Linux Netfilter.

11. An intermediate device in accordance with claim 7, wherein the dispatcher is operable to adapt the transport layer dependent upon received acknowledgement (ACK) messages.

12. An intermediate device in accordance with claim 7, wherein the dispatcher is operable to adapt the transport layer dependent upon properties of a link between the intermediate device and the first node.

13. An intermediate device in accordance with claim 12, further comprising a user interface operable to enable an operator of the intermediate device to enter the properties of the link between the intermediate device and the first node.

14. A network comprising:
an intermediate device for adapting communication between a first node and a second node of a network, the intermediate device comprising:
a network layer, operable to send and receive message packets from the first node and the second node, each message packet comprising a source address and a destination address in a network routing header and a source port identifier and a destination port identifier in a transport header;
a transport layer, operable to send and receive message packets from the network layer;
a splitter operable to:
intercept a message packet in the network layer, and
modify the network routing header and transport header of the message packet to form a modified message packet;
a dispatcher, operable to:
receive modified message packets from the transport layer;
recover information from the message packets;
pass the modified message packets back to the transport layer; and
adapt the transport layer to optimize communication dependent upon the information recovered from the message packets; and
a connections database, operable to store the original source address, the original destination address, the original source port identifier and the original destination port identifier of an incoming message packet;
wherein the routing header and transport header of a message packet is modified, with reference to the connections database, such that message packets from the first and second nodes are routed to the dispatcher, and message packets from the dispatcher are routed to one of the first and second nodes;
a first node, operable to connect with the intermediate device via a wireless link; and
a second node, operable to connect with the intermediate device;
wherein the first node is operable to connect with the second node through the intermediate and the intermediate device is operable to adapt communication between the first node and the second node.
